(19) United States
(12) Patent Application Publication
(10) Pub. No.: US 2007/0064660 A1
(43) Pub. Date: Mar. 22, 2007

(54) Techniques for enhanced transition from access point to access point by a mobile wireless device

(76) Inventors: Emily H. Qi, Portland, OR (US); Jesse Walker, Portland, OR (US); Kapil Sood, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/231,005

(22) Filed: Sep. 16, 2005

(51) Int. Cl. H04Q 7/24

(52) U.S. Cl. 370/338

(57) ABSTRACT

Before a transition from a current access point (AP) to a new AP, a mobile wireless station (STA) may determine mobility capabilities, network infrastructure and resource information that may be used to select a transition mechanism to use via information acquired by the current AP regarding the new AP.

### TECHNICAL FIELD

Embodiments of the invention relate to wireless communications. More particularly, embodiments of the invention relate to

### BACKGROUND

Wireless local area networks (WLANs) generally include one or more access points (APs) and one or more mobile wireless stations (STAs). These APs and STAs may communicate using any wireless protocol, for example, IEEE 802.11b and/or IEEE 802.11g. IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents. Related documents may include, for example, IEEE 802.11a and upcoming IEEE 802.11n.

During operation a STA may transition from a current AP to a new AP for various reasons, for example, degraded link characteristics, etc. With some types of data and applications, for example, voice over IP (VoIP) and multimedia, transitions between APs may interrupt service using current techniques. Current techniques for advertising roaming/transition policy and configuration are inefficient. Another potential consequence of transitions between APs is a different quality of service (QoS) provided by the new AP. Thus, current transition mechanisms may result in unsatisfactory network performance.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of a network having at least two wireless access points and a mobile wireless station.

FIG. 2 is a flow diagram of an access point request-response transaction.

FIG. 3 is one embodiment of a Transition AP Request Frame that may be used to request information related to one or more target APs.

FIG. 4 is one embodiment of a Transition AP Report Frame that may be used to request information related to one or more target APs.

FIG. 5 is one embodiment of a Fast Transition Resource Information Element that may be used to report information corresponding to target APs.

FIG. 6 is a block diagram of one embodiment of an electronic system.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

In one embodiment, before a transition from a current access point (AP) to a new AP, a mobile wireless station (STA) may determine mobility capabilities, network infrastructure and resource information that may be used to select a transition mechanism to use. IEEE 8002.11 Task Group R (IEEE 802.11r) has proposed a Fast Transition Resource Information Element (FTRIE), a Fast Transition Security Information Element (FTSIE) and a Fast Transition Key Holder Information Element (FTKHIE) that may allow an AP to advertise network infrastructure and resource information through a beacon frame and probe response frame.

IEEE 802.11r corresponds to IEEE 802.11r/D0.05 entitled “Draft Amendment to STANDARD FOR Information Technology—Telecommunications and Information Exchange Between Systems—LAN/MAN Specific Requirements: Part 11: Wireless Medium Access Control (MAC) and physical layer (PHY) Specifications: Amendment 8: Fast BSS Transition,” approved July 2005 as well as related documents. In one embodiment, FTRIE may be 18 bytes long, FTSIE may be 64 bytes long, and FTKHIE may be larger than 100 bytes. Including such large Information Elements (IEs) in beacons may overburden the beacon frame. Because all of fields in these IEs may store static information, it may not be necessary for an AP to advertise this information through the beacon frame. Advertising static information through a beacon frame may reduce the network throughput.

In one embodiment, instead of advertising network infrastructure and/or other information with a beacon frame, techniques described herein allow a STA to inquire about AP policies and/or resource information through a current AP. An AP may provide a network transition policy and/or resource and security availability information for another AP (e.g., a potential target, or new, AP). If, for example, the transition policy or resource availability of a target AP does not meet the requirements of the STA, the STA may not attempt to receive a beacon from the potential target AP. The technique described herein may relieve the STA from probe requests to APs. This may improve the efficiency of a communication protocol and network throughput. This may also improve STA scanning processing and reduce STA power consumption.

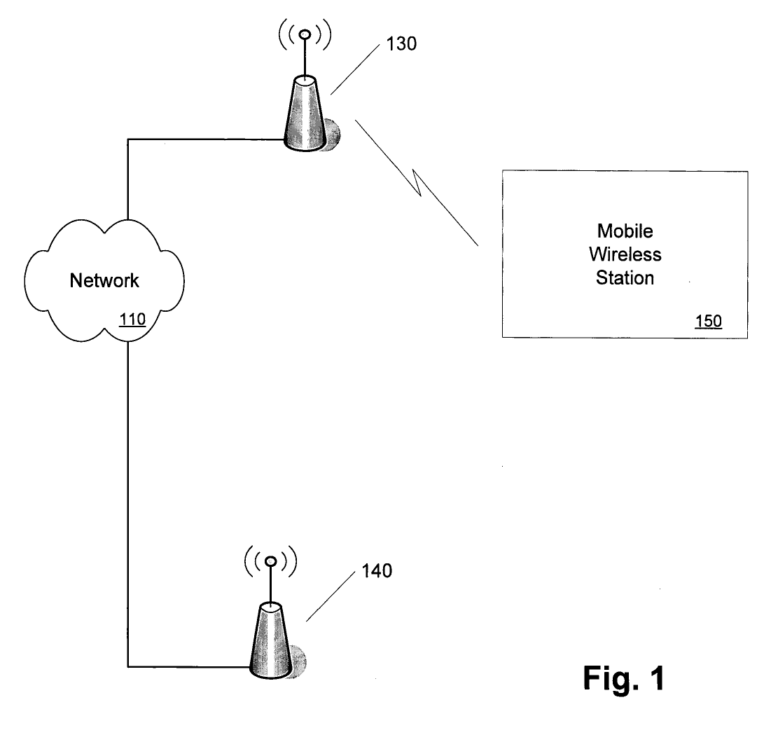

FIG. 1 is a block diagram of a network having at least two wireless access points and a mobile wireless station. The example of FIG. 1 includes network 110 (wired and/or wireless) coupled with two wireless access points (130, 140) for reasons of simplicity only. Any number of network nodes including any number of wireless access points may be supported. Further, any number of mobile wireless stations (e.g., 150) may be supported. As described in greater detail below, a mobile wireless station may be any type of device capable of communicating using the wireless communication protocol(s) supported by access points 130 and 140.

In one embodiment, mobile wireless station 150 may be wirelessly connected with access point 130. The wireless connection may carry, for example, a Voice over IP (VoIP) call where quality of service (QoS) may be a relevant factor when transitioning between access points. Wireless mobile station 150 may send a message to access point 130 to acquire information that may be used for a transition to access point 140.

The requested information may be obtained by a wired or wireless transaction between access point 130 and access point 140. Any transaction that provides relevant information may be used. One embodiment of a messaging structure that may be used to communicate between access point 130 and access point 140 is described in greater detail below. The information acquired by access point 130 may then be transmitted to wireless mobile station 150 and may be used in a transition between access point 130 and access point 140.

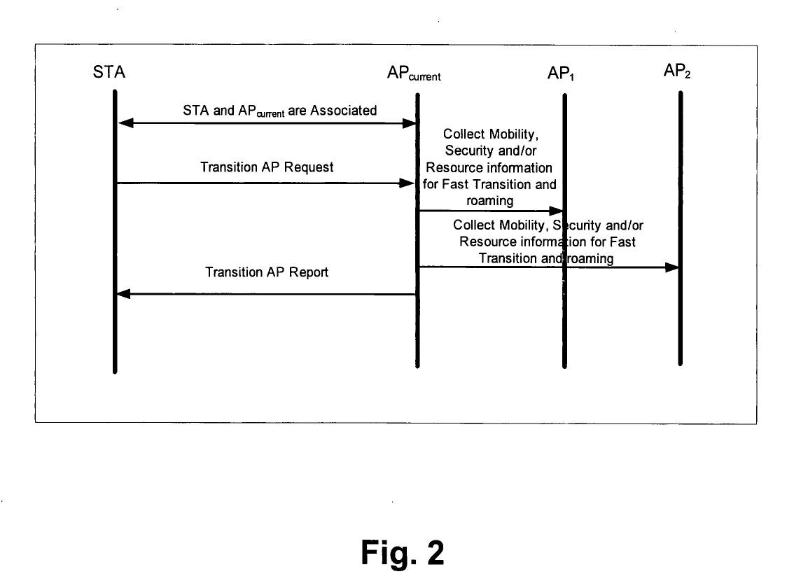

FIG. 2 is a flow diagram of an access point request-response transaction. A wireless station (STA) and an access point (AP_{current}) are associated. The association can be accomplished in any manner known in the art. In one embodiment, the STA may transmit a Transition AP Request to the AP_{current} that may include a Basic Service Set Identifier (BSSID) list that may identify APs of interest for which information may be acquired. The BSSID is the medium access control (MAC) address of the target APs (e.g., AP₁, AP₂).

The AP receiving the Transition AP Request (AP_{current}) may then communicate with the APs to acquire mobility, security and/or resource information. AP_{current} may then generate a Transition AP Report that may carry the acquired mobility, security and/or resource information to the requesting STA. In one embodiment the Transition AP Request message and/or the Transition AP Report may be protected by use of security keys and/or other cryptographic techniques. In one embodiment, AP_{current} may periodically gather mobility, security and/or resource information and transmit a Transition AP Report without receiving a Transition AP Request from the STA.

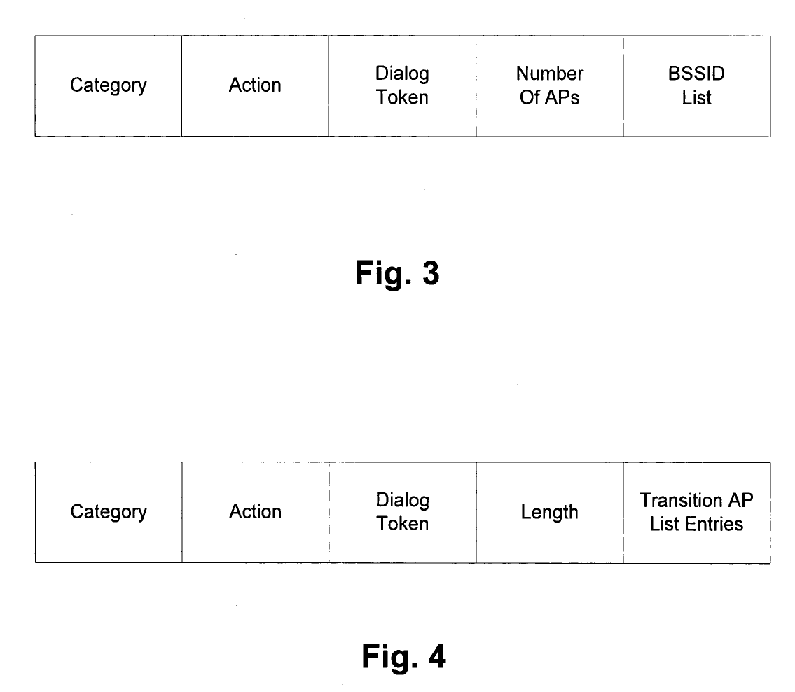

FIG. 3 is one embodiment of a Transition AP Request Frame that may be used to request information related to one or more target APs. The Transition AP Request Frame can be used, for example, as a variation to the IEEE 802.11r proposal cited above. However, use of the Transition AP Request Frame is not limited to IEEE 802.11 wireless protocols.

In one embodiment, the Transition AP Request Frame may transmitted from a wireless station to an access point that the wireless station is associated with and may include the following fields: Category, Action, Dialog Taken, Number of APs and BSSID List. The Category field may include a value that may be used to indicate a Fast Transition category as defined by the IEEE 802.11r proposal. The Action field may be used to indicate that the Transition AP Request Frame corresponds to a Fast Transition request. The Dialog Token field may be set to a value chosen by the sending wireless station to identify the request-report transaction.

The Number of APs field may indicate the number of APs for which the wireless station is requesting information. In one embodiment, if the Number of APs field is set to 0, the receiving AP may collect information for all neighboring APs. The BSSID List field may include a list of BSSIDs corresponding to the APs for which information is requested. Additional, fewer and/or different fields may also be supported.

FIG. 4 is one embodiment of a Transition AP Report Frame that may be used to request information related to one or more target APs. The Transition AP Report Frame can be used, for example, as a variation to the IEEE 802.11r proposal cited above. However, use of the Transition AP Report Frame is not limited to IEEE 802.11 wireless protocols.

In one embodiment, the Transition AP Report Frame may be transmitted from an access point to a wireless station from which a corresponding Transition AP Request Frame has been received and may include the following fields: Category, Action, Dialog Taken, Length and Transition AP List Entries. The Category field may include a value that may be used to indicate a Fast Transition category as defined by the IEEE 802.11r proposal. The Action field may be used to indicate that the Transition AP Request Frame corresponds to a Fast Transition request. The Dialog Token field may be set to a value chosen by the sending wireless station to identify the request-report transaction.

In one embodiment, The Length field may be dependent on the number of Fast-Transition AP List Entries being reported. Each entry in the Transition AP List Entries may describe an AP's fast transition policy and may include mobility, quality of service (QoS) and/or security resource information. This information is currently defined as Mobility Domain Identifier IE, Fast Transition Resource IE, Fast Transition Security IE, and Fast Transition Key Holder IE, in IEEE 802.11r draft 0.1, but could be specified in alternate formats, as well.

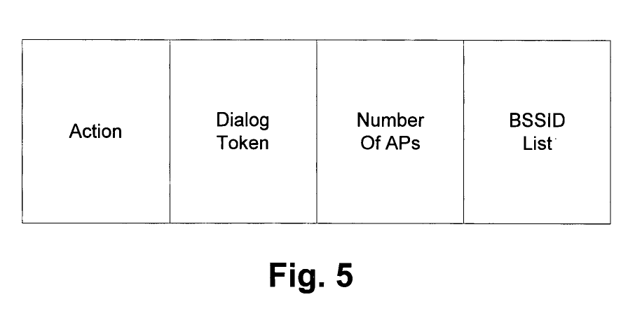

FIG. 5 is one embodiment of a Fast Transition Resource Information Element that may be used to report information corresponding to target APs. The current IEEE 802.11r draft uses a beacon frame and a probe response frame to advertise network infrastructure policy and resource information. The policy and resource information include Fast Transition Resource IE (FTRIE), Fast Transition Security IE (FTSIE) and Fast Transition Key Holder IE (FTKHIE). Because the FTTIE is 18 bytes long, the FTSIE is 64 bytes long, and FTKHIE can be larger than 100 bytes, including such long IEs in the beacon may overburden the beacon frame. The beacon frame is usually advertised by an AP every 100 ms.

Instead of advertising network infrastructure policy through beacon frame and probe response, the techniques described herein may provide a mechanism to allow a wireless station to inquire about policies of one or more target access points through the current access point and to enable an access point to advertise policies and resource information for other access points.

In one embodiment, the wireless station (STA) may acquire this information without performing expensive channel switch operations. This means that the STA may not be required to go off-channel to communicate with multiple APs to get this information from those APs. Channel switches may be power expensive and may use valuable battery life, in addition to being complex operations.

The techniques described herein may provide several advantages. For example, the protocol efficiency and the network throughput may be improved by advertising static policy for mobility, security and resource information through a frame other than a beacon or a response. The resulting reduction in scanning processing may reduce the power consumption by the wireless station. In one embodiment, information in the Transition AP Request and Transition AP Report messages may be protected using management frame protection schemes, which cannot be applied to beacon and probe messages.

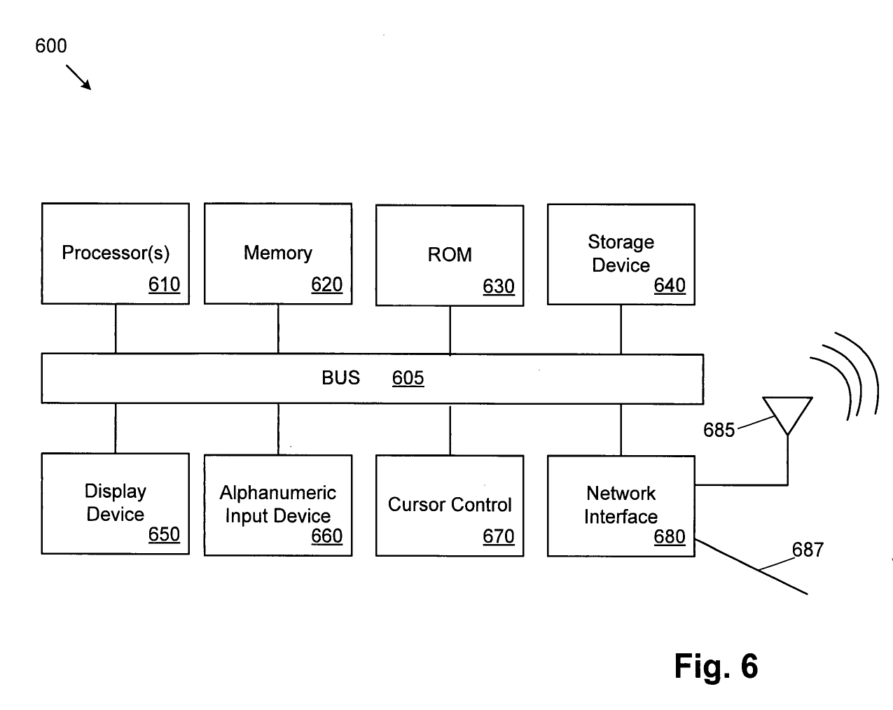

FIG. 6 is a block diagram of one embodiment of an electronic system. The electronic system illustrated in FIG. 6 is intended to represent a range of electronic systems that may operate as wireless stations including, for example, desktop computer systems, laptop computer systems, cellular telephones, personal digital assistants (PDAs) including cellular-enabled PDAs, set top boxes. Alternative electronic systems may include more, fewer and/or different components.

Electronic system 600 includes bus 605 or other communication device to communicate information, and processor 610 coupled to bus 605 that may process information. While electronic system 600 is illustrated with a single processor, electronic system 600 may include multiple processors and/or co-processors. Electronic system 600 further may include random access memory (RAM) or other dynamic storage device 620 (referred to as main memory), coupled to bus 605 and may store information and instructions that may be executed by processor 610. Main memory 620 may also be used to store temporary variables or other intermediate information during execution of instructions by processor 610.

Electronic system 600 may also include read only memory (ROM) and/or other static storage device 630 coupled to bus 605 that may store static information and instructions for processor 610. Data storage device 640 may be coupled to bus 605 to store information and instructions. Data storage device 640 such as a magnetic disk or optical disc and corresponding drive may be coupled to electronic system 600.

Electronic system 600 may also be coupled via bus 605 to display device 650, such as a cathode ray tube (CRT) or liquid crystal display (LCD), to display information to a user. Alphanumeric input device 660, including alphanumeric and other keys, may be coupled to bus 605 to communicate information and command selections to processor 610. Another type of user input device is cursor control 670, such as a mouse, a trackball, or cursor direction keys to communicate direction information and command selections to processor 610 and to control cursor movement on display 650.

Electronic system 600 further may include network interface(s) 680 to provide access to a network, such as a local area network. Network interface(s) 680 may include, for example, a wireless network interface having antenna 685, which may represent one or more antenna(e). Network interface(s) 680 may also include, for example, a wired network interface to communicate with remote devices via network cable 687, which may be, for example, an Ethernet cable, a coaxial cable, a fiber optic cable, a serial cable, or a parallel cable.

In one embodiment, network interface(s) 680 may provide access to a local area network, for example, by conforming to IEEE 802.11b and/or IEEE 802.11g standards, and/or the wireless network interface may provide access to a personal area network, for example, by conforming to Bluetooth standards. Other wireless network interfaces and/or protocols can also be supported.

In addition to, or instead of, communication via wireless LAN standards, network interface(s) 680 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

1. A method comprising:
generating a request message, with a wireless device communicating with a current wireless access point, to request from the current wireless access point operational information corresponding to one or more target wireless access points; and
receiving, in response to the request message, a report message having the operational information corresponding to each of the one or more target wireless access points.

2. The method of claim 1 further comprising transitioning to a new wireless access point selected from the one or more target wireless access points using the operational information corresponding to the new wireless access point.

3. The method of claim 1 wherein the operational information comprises network security policies, network access policies, cryptographic key availability information and/or resource availability information.

4. The method of claim 1 wherein the operational information comprises roaming and/or fast transition information.

5. The method of claim 1 wherein the wireless device communicates with the wireless access point according to an IEEE 802.11 protocol.

6. The method of claim 1 wherein the request message and the report message are communicated in a secure manner.

7. A method comprising:
receiving, with a current wireless access point, a request message from a wireless device requesting operational information for other wireless access points communicatively coupled with the current wireless access point;
communicating, via the current wireless access point, in response to the request message, with the other wireless access points to acquire the operational information corresponding to the other wireless access points; and
transmitting from the current wireless access point to the wireless device a report message having the acquired operational information.

8. The method of claim 7 wherein the operational information comprises network security policies, network access policies, cryptographic key availability information and/or resource availability information.

9. The method of claim 7 wherein the operational information comprises roaming and/or fast transition information.

10. The method of claim 7 wherein the wireless device communicates with the wireless access point according to an IEEE 802.11 protocol.

11. The method of claim 7 wherein the request message and the report message are communicated in a secure manner.

12. An article comprising a computer-readable medium having stored thereon instructions that, when executed, cause one or more processors to:
generate a request message, with a wireless device communicating with a current wireless access point, to request from the current wireless access point operational information corresponding to one or more target wireless access points; and
receive, in response to the request message, a report message having the operational information corresponding to each of the one or more target wireless access points.

13. The article of claim 12 further comprising transitioning to a new wireless access point selected from the one or more target wireless access points using the operational information corresponding to the new wireless access point.

14. The article of claim 12 wherein the operational information comprises network security policies, network access policies, cryptographic key availability information and/or resource availability information.

15. The article of claim 12 wherein the operational information comprises roaming and/or fast transition information.

16. The article of claim 12 wherein the wireless device communicates with the wireless access point according to an IEEE 802.11 protocol.

17. The article of claim 12 wherein the request message and the report message are communicated in a secure manner.

18. An article comprising a computer-readable medium having stored thereon instructions that, when executed, cause one or more processors to:
receiving, with a current wireless access point, a request message from a wireless device requesting operational information for other wireless access points communicatively coupled with the current wireless access point;
communicating, via the current wireless access point, in response to the request message, with the other wireless access points to acquire the operational information corresponding to the other wireless access points; and
transmitting from the current wireless access point to the wireless device a report message having the acquired operational information.

19. The article of claim 18 wherein the operational information comprises network security policies, network access policies, cryptographic key availability information and/or resource availability information.

20. The article of claim 18 wherein the operational information comprises roaming and/or fast transition information.

21. The article of claim 18 wherein the wireless device communicates with the wireless access point according to an IEEE 802.11 protocol.

22. The article of claim 18 wherein the request message and the report message are communicated in a secure manner.

23. A wireless device comprising:
a control circuit;
a transmitter coupled with the control circuit to transmit wireless signals to a current access point to request from the current wireless access point operational information corresponding to one or more target wireless access points; and
a receiver coupled with the control circuit to receive, in response to the request message, a report message having the operational information corresponding to each of the one or more target wireless access points.

24. The wireless device of claim 23 wherein the control circuit causes a transition to a new wireless access point selected from the one or more target wireless access points using the operational information corresponding to the new wireless access point.

25. The wireless device of claim 23 wherein the operational information comprises network security policies, network access policies, cryptographic key availability information and/or resource availability information.

26. The wireless device of claim 23 wherein the operational information comprises roaming and/or fast transition information.

27. The wireless device of claim 23 wherein the transmitter and the receiver transmit and receive data to and from the wireless access point according to an IEEE 802.11 protocol.

28. A wireless system comprising:
one or more omnidirectional antennae;
a control circuit;
a transmitter coupled with at least one of the one or more antennae and with the control circuit to transmit wireless signals to a current access point to request from the current wireless access point operational information corresponding to one or more target wireless access points; and
a receiver coupled with at least one of the one or more antennae and with the control circuit to receive, in response to the request message, a report message having the operational information corresponding to each of the one or more target wireless access points.

29. The wireless system of claim 28 wherein the control circuit causes a transition to a new wireless access point selected from the one or more target wireless access points using the operational information corresponding to the new wireless access point.

30. The wireless system of claim 28 wherein the operational information comprises network security policies, network access policies, cryptographic key availability information and/or resource availability information.

31. The wireless system of claim 28 wherein the operational information comprises roaming and/or fast transition information.

32. The wireless system of claim 28 wherein the transmitter and the receiver transmit and receive data to and from the wireless access point according to an IEEE 802.11 protocol.

33. A wireless access point comprising:
a receiver to receive wireless messages form at least a wireless station associated with the wireless access point;
a transmitter to transmit wireless messages to at least a wireless station associated with the wireless access point;
a network interface to communicate with remote wireless access points; and
a control circuit coupled with the receiver, the transmitter and the network interface, the control circuit to communicate, via the network interface, in response to a request message from the wireless station, with the remote wireless access points to acquire the operational information corresponding to the wireless access point and to cause to be transmitted to the wireless station, a report message having acquired operational information obtained form the remote wireless access point.

34. The wireless access point of claim 33 wherein the operational information comprises network security policies, network access policies, cryptographic key availability information and/or resource availability information.

35. The wireless access point of claim 33 wherein the operational information comprises roaming and/or fast transition information.

36. The wireless access point of claim 33 wherein the wireless device communicates with the wireless access point according to an IEEE 802.11 protocol.

37. A wireless access point system comprising:
one or more substantially omnidirectional antennae;
a receiver coupled with at least one of the antennae to receive wireless messages form at least a wireless station associated with the wireless access point;
a transmitter coupled with at least one of the antennae to transmit wireless messages to at least a wireless station associated with the wireless access point;
a network interface to communicate with remote wireless access points; and
a control circuit coupled with the receiver, the transmitter and the network interface, the control circuit to communicate, via the network interface, in response to a request message from the wireless station, with the remote wireless access points to acquire the operational information corresponding to the wireless access point and to cause to be transmitted to the wireless station, a report message having acquired operational information obtained form the remote wireless access point.

38. The wireless access point system of claim 37 wherein the operational information comprises network security policies, network access policies, cryptographic key availability information and/or resource availability information.

39. The wireless access point system of claim 37 wherein the operational information comprises roaming and/or fast transition information.

40. The wireless access point system of claim 37 wherein the wireless device communicates with the wireless access point according to an IEEE 802.11 protocol.
